(19) United States
(12) Patent Application Publication
(10) Pub. No.: US 2022/0270519 A1
(43) Pub. Date: Aug. 25, 2022

(54) CARD DISPLAY AND RETENTION SYSTEM

(71) Applicant: Show Your Slabs, LLC, Essex, MD (US)

(72) Inventor: Corey Fick, Essex, MD (US)

(21) Appl. No.: 17/562,737

(22) Filed: Dec. 27, 2021

Related U.S. Application Data
(60) Provisional application No. 63/200,247, filed on Feb. 24, 2021.

(51) Int. Cl. G09F 1/12; A63F 1/06

(52) U.S. Cl. CPC G09F 1/12; A63F 1/062; G09F 2001/106

(57) ABSTRACT

A card display and retention system for displaying graded card collections and memorabilia. The card display and retention system has a single-piece display body with a pocket defined. The pocket includes sidewalls, an adhesive within each pocket, and a card holder configured to be inserted into the pocket and be retained by only the pocket and the adhesive. The display body defines a plurality of pockets that are sized to retain a plurality of card holders that contain cards.

### CROSS-REFERENCE TO RELATED APPLICATIONS

This application claims the benefit of the filing date of U.S. Provisional Application Ser. No. 63/200,247 titled “Card Display and Retention System” and filed Feb. 24, 2021, and the subject matter of which is incorporated herein by reference.

### STATEMENT REGARDING FEDERALLY SPONSORED RESEARCH OR DEVELOPMENT

Not applicable.

### INCORPORATION BY REFERENCE OF MATERIAL SUBMITTED ON A COMPACT DISC

Not applicable.

### TECHNICAL FIELD

The present disclosure relates to the field of card displays, and more specifically to the field of displays for graded card collections and memorabilia.

### BACKGROUND

The present invention relates to card displays, and more specifically, displays for graded card collections and memorabilia. The display utilized both measured fit and adhesive to hold cards in place.

Graded cards and memorabilia such as baseball, basketball, and football cards have been collected for many years. Originally intended for young children as a hobby, it eventually became a popular hobby among adults as well. This hobby further developed into a multimillion-dollar trade industry among hobbyists and collectors. Cards can be purchased, traded, or auctioned at a multitude of venues across the world, such as, sports specialty shops, pawn shops, card shows, sports memorabilia auctions, online, etc. In addition to cards, other encased collectables, such as coins and stamps, for example, are highly desirable among collectors; however, these encased collectibles are difficult to display.

Graded cards, coins, and stamps get their value from their desirability, which can be measured by a number of factors. Factors that are considered in the evaluation of a collectible item can be: the brand or manufacturer, associated sport, depicted athlete, manufacturing year, rarity, and condition. For cards, such as sports cards or trading cards, the cards physical condition may be the most important factor in grading since even the slightest smudge, crease, or tear can render a card valueless, regardless of the other existing factors. A graded card's condition is also important for display purposes. Much like paintings, statues, and other forms of art, graded cards are meant to be displayed for others to admirer. Moreover, the higher grading a card or collectible receive from a third-party grader, generally, the more valuable the collectible item becomes.

Existing displays do not form fit the graded card nor do they keep them in place while being displayed. These displays do not work well because an individual must either remove a cover to access the card or there is nothing surrounding the measurement of the graded card to protect it from potentially falling. This is not ideal since even the slightest defect can harm the value of the graded card. These displays also do not allow an individual to easily remove or interchange the displayed cards. Instead, if an individual wants to remove a single card or rearrange a display, he must remove the card(s) entirely from any protective covering, thus, subjecting it to potential damage. Since these displays are commonly used in sports memorabilia shops, it is ideal to for owners to have a graded card display that that allows for easy removal and rearranging of cards without putting them in harm's way.

As a result, there exists a need for improvements over the prior art and more particularly for a more efficient way of organizing and displaying graded cards without subjecting them to potential harm.

### SUMMARY

A system for retaining and displaying items is disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a system for retaining and displaying items is disclosed. The system comprises a display body having a display body front facing side. A plurality of item receiving recesses on the display body front facing side, wherein each of the item receiving recesses comprises a ledge. A plurality of item holders, wherein each is configured to be removably received by at least one of the plurality of item receiving recesses. A first item holder front facing side of a first item holder of the plurality of item holders is substantially flush with a second item holder front facing side of a second item holder of the plurality of item holders when the first and second item holders are received by two of the plurality of item receiving recesses.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the disclosure and together with the description, explain the principles of the disclosed embodiments. The embodiments illustrated herein are presently preferred, it being understood, however, that the disclosure is not limited to the precise arrangements and instrumentalities shown, wherein:

FIG. 1 is a front view of a display system for retaining and displaying items, according to an example embodiment;

FIG. 2 is a top perspective view of the display system for retaining and displaying items, according to an example embodiment;

FIG. 3 is a cross-section side view of a portion of the display system for retaining and displaying items, according to an example embodiment;

FIG. 4 is a perspective view of an item holder, according to an example embodiment;

FIG. 5 is a front view of the display system including item holders, according to an example embodiment;

FIG. 6 is a perspective view of the display system including item holders and a tool, according to an example embodiment;

FIG. 7 is a bottom view of the display system including item holders, according to an example embodiment;

FIG. 8 is a cross-section side view of a second portion of the display system including item holders, according to an example embodiment;

FIG. 9 is a perspective view of the tool, according to an example embodiment;

FIG. 10 is a side perspective view of the display system including item holders and the tool, according to an example embodiment;

FIG. 11 is a side perspective view of the display system including item holders and the tool, according to an example embodiment;

FIG. 12 is a cross-section side view of a third portion of the display system including item holders, according to an example embodiment;

FIG. 13 is a side perspective view of the display system including item holders, according to an example embodiment;

FIG. 14 is a side perspective view of the display system including item holders and the tool, according to an example embodiment; and

FIG. 15 is a block diagram illustrating a method for retaining and displaying items, according to an example embodiment.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions, or modifications may be made to the elements illustrated in the drawings, and the methods described herein may be modified by substituting reordering or adding additional stages or components to the disclosed methods and devices. Accordingly, the following detailed description does not limit the disclosed embodiments. Instead, the proper scope of the disclosed embodiments is defined by the appended claims.

The disclosed embodiments improve upon the problems with the prior art by providing a system of retaining and displaying graded cards without subjecting them to potential harm. The item holders safely hold a card by encasing it to prevent wear from fingers or other objects. The item holders are transparent so the graded card to be viewed through the item holder. The dimensions of the plurality of item receiving recesses on the display body are configured to allow an item holder to fit flush within an item receiving recess such that the card may be removably stored on the display body. In order to remove an item holder from the display body, a tool is configured to safely remove the item holder from the display body without any damage or harm to the grade card because a user does not have to directly touch the item within the item holder.

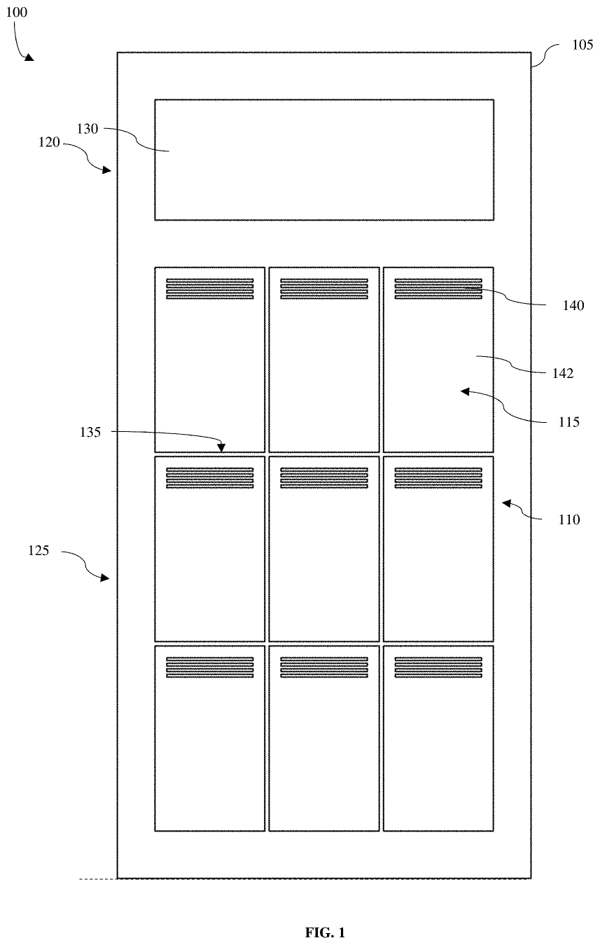

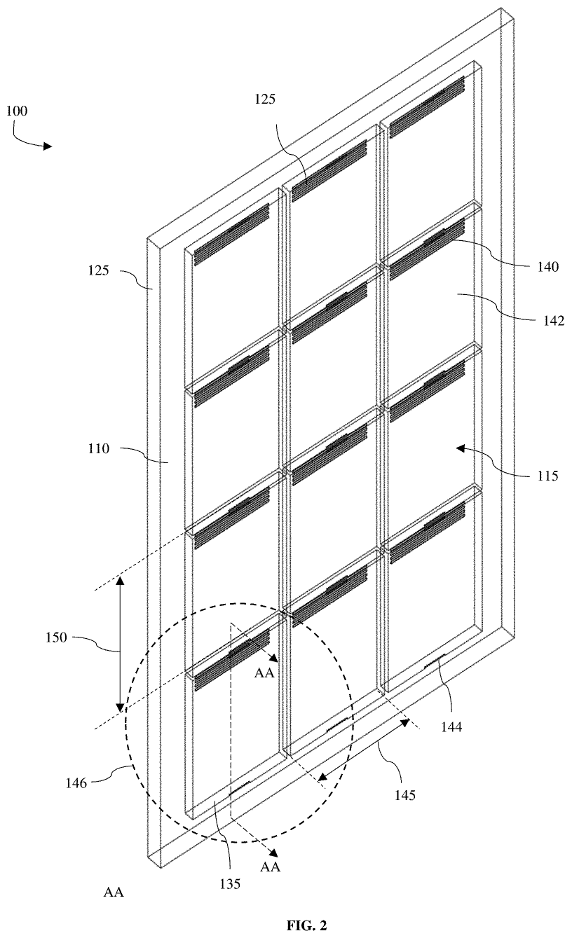

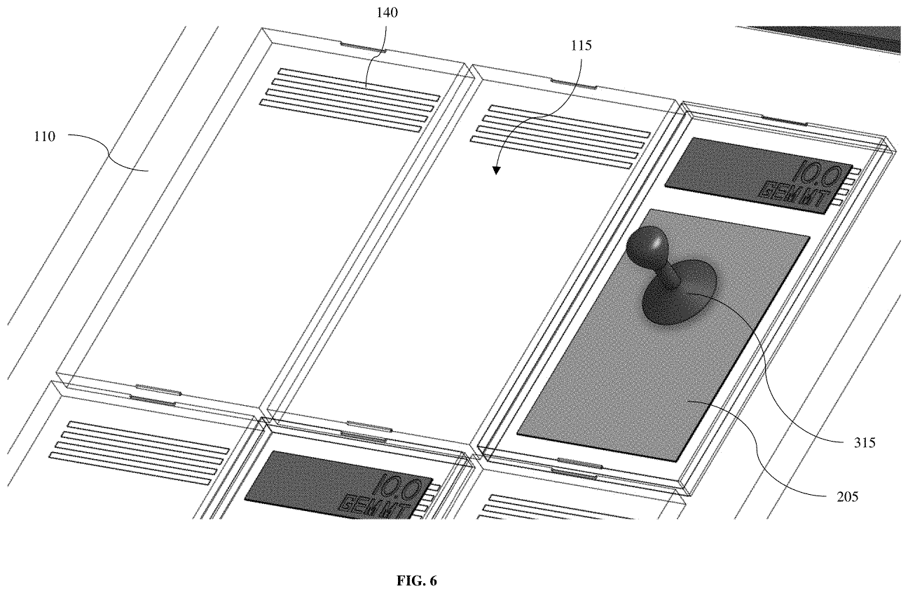

Referring now to the Figures, FIG. 1 is a front view of a display system 100 for retaining and displaying items, according to an example embodiment. The display system includes a display body 105 having a display body front facing side 110. The display body front facing side includes a plurality of item receiving recesses 115 and is on the side that is mean to be viewed by the user. The display body further comprises an upper display body section 120 and a lower display body section 125. The upper display body section comprises an ornamental grading plate 130. The lower display body section comprises the plurality of item receiving recesses. The item receiving recesses are rectangular empty spaces on the display body front facing side. The upper display body section is positioned above the lower display body section such that the plurality of item receiving recesses may be below the ornamental grading plate. Each of the item receiving recesses comprises a ledge 135 (more easily seen in FIG. 2A). The ledge is the bottom edge of the item receiving recesses. In certain embodiments, the ledge may be angled upwards towards the display body front facing side 110 and downwards towards a back wall 142 of the item receiving recess to allow the item holder to fall into the recess. The upward angle will retain the item holder within the item receiving recess because it will prevent the item holder from falling out of or sliding out of the item receiving recess absent some external force. The system further includes a plurality of item holders 200. Each item holder includes an item holder front facing side 205 that is positioned to viewed by the user. The item holder front facing side displays the side of the item in the item holder that the user may want to display. The item holder front facing side is faced in the same direction as the display body front facing side. Each of the plurality of item holders is configured to be removably received by at least one of the plurality of item receiving recesses 115. The item receiving recesses may be shaped to hold the item holders. The display system may further include at least one fastener 140. Each fastener may removably secures one of the plurality of item holders within one of the plurality of item receiving recesses. The display system comprises a tool 300 (illustrated in FIG. 6) comprising a tool first end portion 305 and a tool second end portion 310. The tool first end portion comprises a suction cup 315, and the tool second end portion comprises a handle 320.

The display body 105 is a device configured to hold at least one item such that the item(s) may be displayed or showcased for others to view the item. The display body may be mantled on a vertical surface or set on a flat horizontal surface using a stand such as a small easel. Other positions of the display body may be used and are within the spirit and scope of the present invention. The display body may be comprised of material such as carbon steel, stainless steel, aluminum, Titanium, other metals or alloys, composites, ceramics, polymeric materials such as polycarbonates, such as Acrylonitrile butadiene styrene (ABS plastic), Lexan™, and Makrolon™. The display body may be made of other materials and is within the spirit and scope of the present invention. The display body may be formed from a single piece or from several individual pieces joined or coupled together. The components of the display body may be manufactured from a variety of different processes including an extrusion process, a mold, welding, shearing, punching welding, folding etc. However, other types of processes may also be used and are within the spirit and scope of the present invention. The ornamental grading plate 130 in the upper display body section may be an engraved plaque that may include information about the grading of the cards in the item holders. The ornamental grading plate may include other information. Each of the plurality of item receiving recesses in the lower display body section includes a fastener to retain an item holder. The fastener allows the item holder to be held on the display body front facing side allowing the item to be displayed and viewed by the user.

The item holder is any device that is configured to encase and retain graded cards or collectable cards for the user. The item holder may be comprised of polymeric materials such as polycarbonates, such as Acrylonitrile butadiene styrene (ABS plastic), Lexan™, and Makrolon™. The item holder may be made of other materials and is within the spirit and scope of the present invention. The item holder may be formed from a single piece or from several individual pieces joined or coupled together. The components of the item holder may be manufactured from a variety of different processes including an extrusion process, a mold, welding, shearing, punching welding, folding etc. However, other types of processes may also be used and are within the spirit and scope of the present invention. The material in the item holder may be transparent allowing the user to view the card within the item holder.

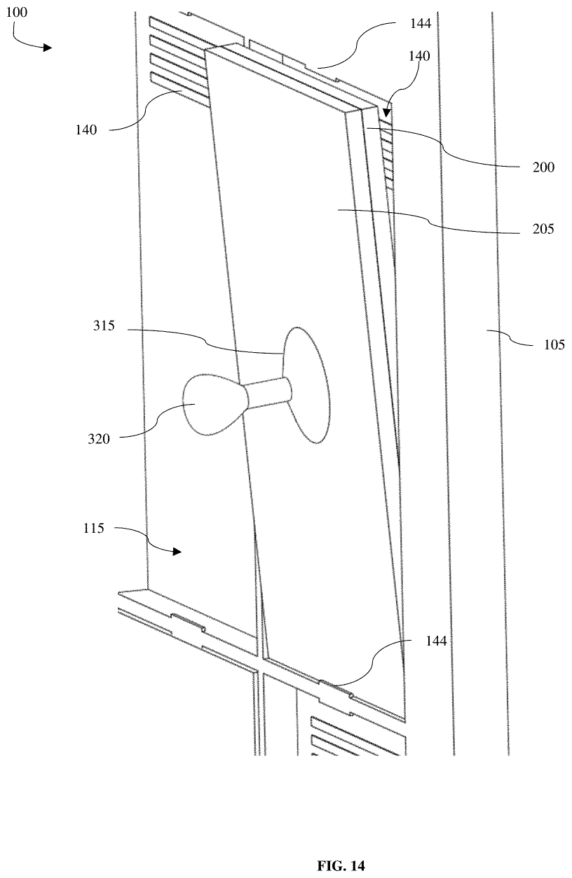

The fastener 140 is configured to retain the item holder within the item receiving recess such that the item holder is secure in the display body. The fastener may be pressure sensitive adhesive material on a back wall 142 of the item receiving recess allowing the item holder to stick to the back wall. The backing of the adhesive material may be made of material, such as wax paper or other materials used to protect adhesive materials. The fastener may also be a magnet, tape, glue, etc. In certain embodiments, the fastener may not be within the item receiving recess. As such, when the item holder is within the item receiving recess, the gap tolerance is configured to press fit or friction-fit the item holder to secure the item holder to the display body. The gaps between the surfaces of the item holder and the item receiving recess may be small enough such that the item holder perfectly fits into the item receiving recess and may be secured within the item receiving recess by the forces of friction acting against the surfaces of the item holder by the surfaces of the item receiving recess. As depicted in FIG. 14, the fastener may also be a lip 144 extending from the display body front facing side over the item receiving recess that prevents the item holder from falling out of the item receiving recess when the item holder is inserted into the item receiving recess. The lip may be merged with the display body during the process of creating the display body or in attachment with the display body as a separate entity. However, other types of fasteners may also be used and are within the spirit and scope of the present invention.

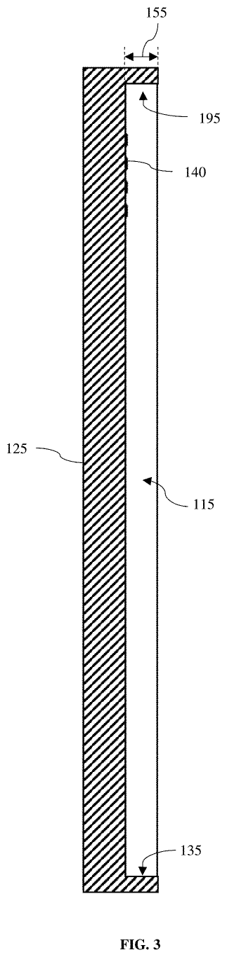

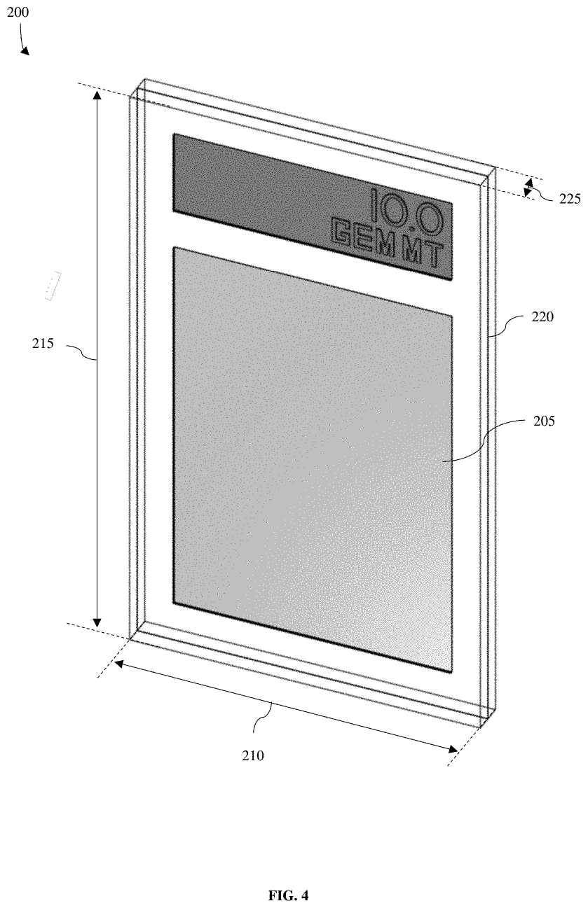

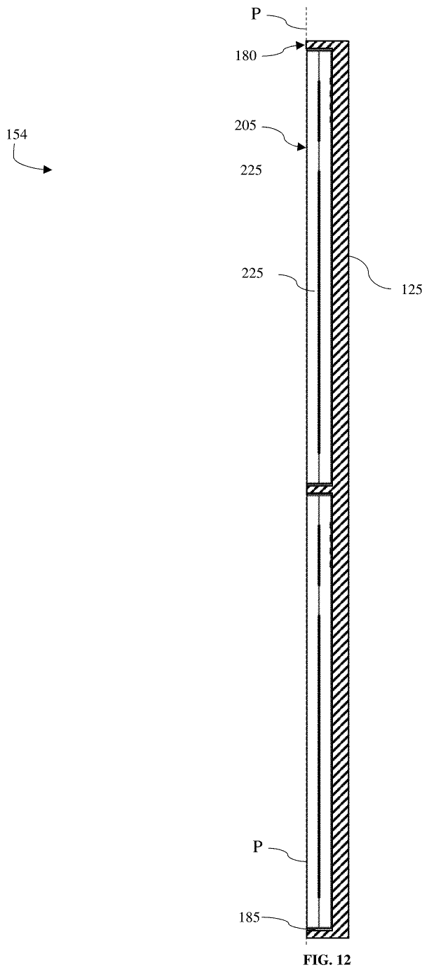

Referring now to FIGS. 2 through 4, views of the display system 100 for retaining and displaying items and the item holders are shown. FIG. 2 is a top perspective view of the display system for retaining and displaying items, according to an example embodiment. FIG. 3 is a cross-section side view of a portion 146 (depicted in FIG. 2) of the display system for retaining and displaying items, according to an example embodiment. The cross-section side view is defined by the cross-section AA, which is a vertical cross-section of the item receiving recess. The FIG. 4 is a perspective view of the item holder, according to an example embodiment. In the present embodiment, the display body may be transparent, as depicted in FIG. 2. However, in other embodiments, the display may not be transparent. Each of the item receiving recesses 115 of the plurality of item receiving recesses has a recess width 145 at least as large as an item holder width 210 of at least one item holder of the plurality of item holders. Each of the item receiving recesses of the plurality of item receiving recesses has a recess height 150 at least as large as an item holder height 215 of at least one item holder of the plurality of item holders. Each of the item receiving recesses 115 of the plurality of item receiving recesses has a recess depth 155 at least as large as an item holder thickness 225 of at least one item holder of the plurality of item holders. While the dimensions, which include the recess depth, the recess height, and the recess width, of the item receiving recesses are at least as large as the dimensions of the item holders, the differences in the dimensions may be small enough for the display body to efficiently hold the item holders such that the item holders are flush or substantially flush with the top surface 180 of the display body (as more easily seen in FIG. 12). The differences in the dimensions allow the item holder to fit in the item receiving recess with minimal movement. The fastener further helps to secure the item holder to prevent the item holder from sliding or dropping out of the item receiving recess. Additionally, the lip prevents further facilitates retaining the item holder within the recess.

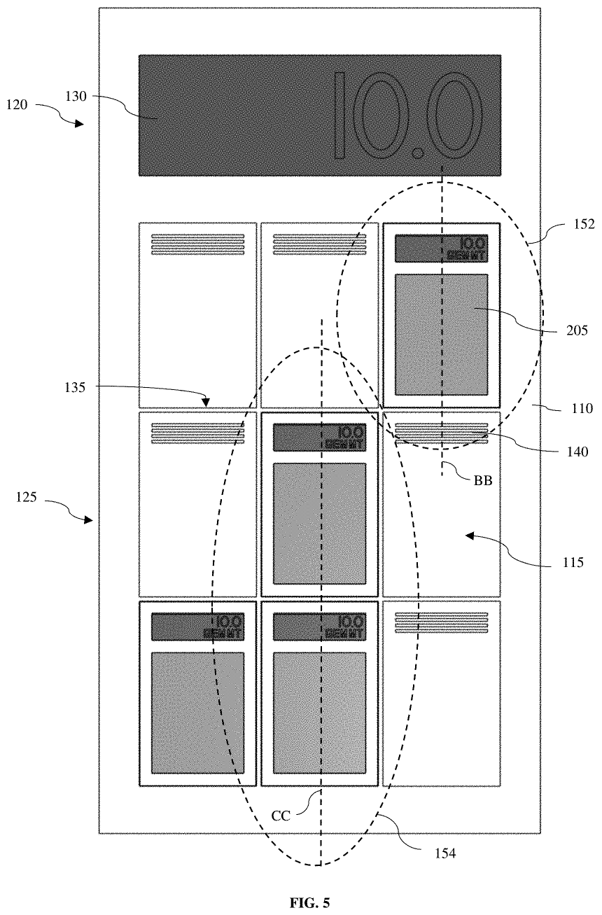

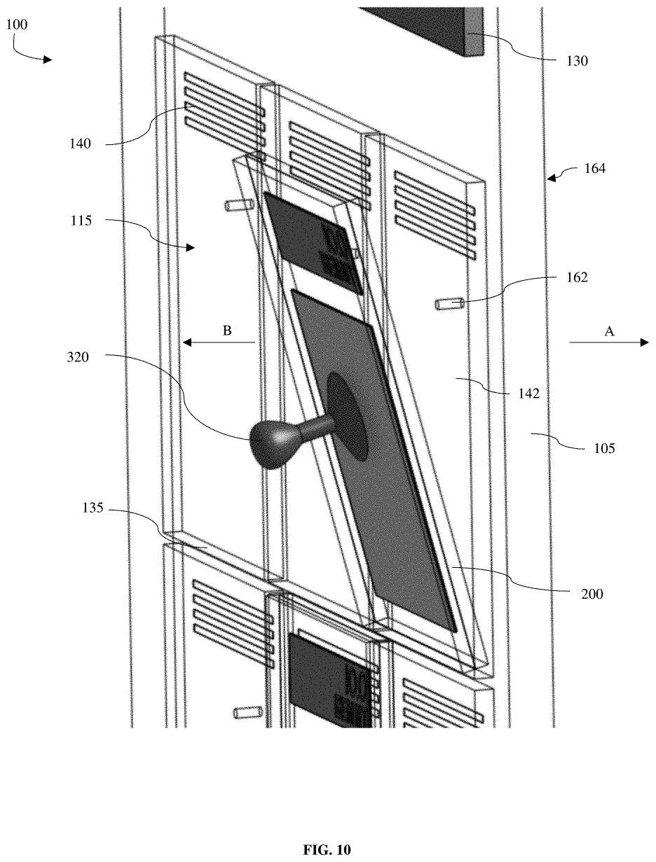

Referring now to FIGS. 5 and 6, views of the display system 100 are shown. FIG. 5 is a front view of the display system 100 for retaining and displaying items including item holders 200, according to an example embodiment. FIG. 6 is a perspective view of the display system 100 including item holders 200 and a tool 300, according to an example embodiment. The display system comprises the display body 105 having a display body front facing side 110 that faces the user such that the user may view the items on the display body. The plurality of item receiving recesses 115 that have a rectangular shape are on the display body front facing side. Each of the item receiving recesses comprises a ledge 135 which is on the bottom edge of the rectangular shape of the item receiving recess. The display system further comprises a plurality of item holders 200. Each of the plurality of item holders is configured to be removably received by at least one of the plurality of item receiving recesses. The item receiving recesses hold the item holders on the display body for the user to view the items. The tool is configured for inserting and removing each of the plurality of item holders into and from each of the plurality of item receiving recesses 115. The display system further comprises at least one fastener. Each fastener is configured to removably secure one of the plurality of item holders within one of the plurality of item receiving recesses. The fasteners allow the item holders to remain on the display body when the display is moved or standing upright. The user may hold the tool by the handle to place the suction cup on the item holder front facing side. The user may apply a little pressure (in the direction toward back side of the display in the direction of arrowed line A in FIG. 10) the handle towards the item holder such that the suction cup adheres to the item holder front facing side. Then, the user may remove the item holder from the recess by pulling on the handle (to apply a force in the direction of arrowed line B in FIG. 10) allowing it to lose connection with the fastener 140.

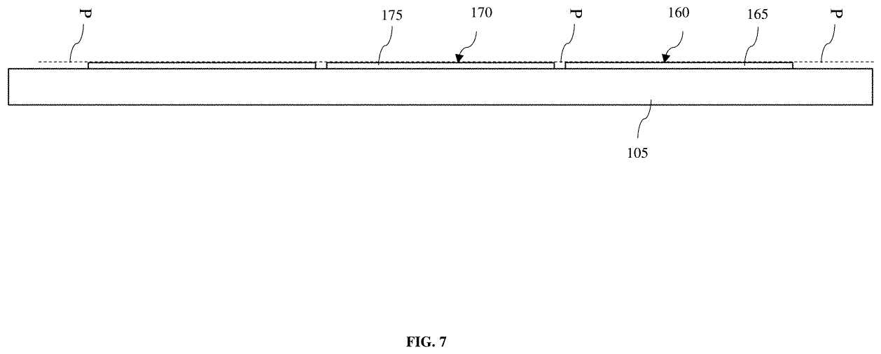

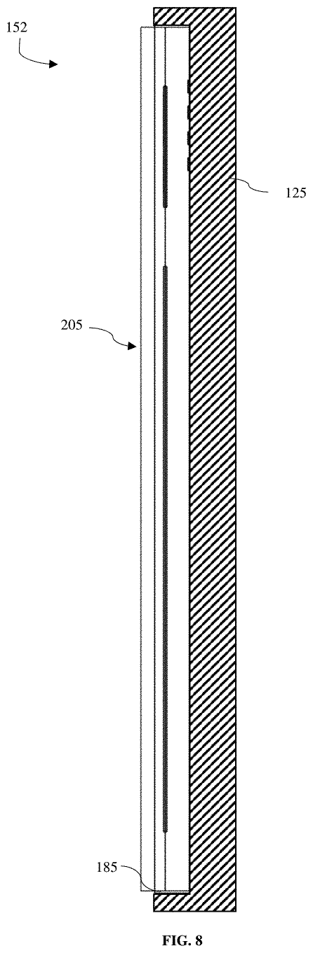

Referring now to FIGS. 7, 8, and 12, views of the item holders in the item receiving recesses are illustrated. FIG. 7 is a bottom view of the display system including item holders, according to an example embodiment. FIG. 8 is a cross-section side view of a second portion 152 (depicted in FIG. 5) of the display system including item holders is shown, according to an example embodiment. The cross-section side view of FIG. 8 is defined by a cross-section represented by the line BB. FIG. 12 is a cross-section side view of a third portion 154 (depicted in FIG. 5) of the display system including item holders, according to an example embodiment. The cross-section side view of FIG. 12 is defined by a cross-section represented by the line CC. A first item holder front facing side 160 of a first item holder 165 of the plurality of item holders 200 is substantially flush with a second item holder front facing side 170 of a second item holder 175 of the plurality of item holders when the first item holder and the second item holder is received by two of the plurality of item receiving recesses 115. The first item holder and second item holder are adjacent when both are in the item receiving recesses. Substantially flush is defined by two sides or surfaces that are on the same plane. For example, when two item holders are retained within adjacent item receiving recesses, the front facing side of each of the two item holders are on the same plane. Therefore, the surfaces of the first item holder front facing side and the second item holder front facing side are on the same plane, which is represented by line P. The item holder front facing side of the first item holder of the plurality of item holders is also substantially flush with a top surface 180 of the display body front facing side 110 when the first item holder is received by one of the plurality of item receiving recesses. The top surface of the display body front facing side is the surface on the outside of the display body front facing side. When the item holders are retained within the item receiving recesses, the item holder front facing side of each of the item holders are on the same plane as the top surface of the display body front facing side.

Each of the item receiving recesses of the plurality of item receiving recesses has a recess depth 155 at least as large as an item holder thickness 225 of at least one item holder of the plurality of item holders. A gap 185 is formed between an item holder side wall 220 of the first item holder and an item receiving recess wall 195 of a first item receiving recess of the plurality of item receiving recesses when the first item holder is received by the first item receiving recess. The gap is at most 0.060 inches to allow the item holder to almost fit snugly into the item receiving recess. The dimensions of the item receiving recesses create the gap for the item holder to be efficiently inserted into the item receiving recess when using the tool. The gap may be small enough such that a fingernail cannot be used to remove the item holder from the item receiving recess. The gap may be configured to allow the surfaces of the item receiving recess to create friction forces against the surfaces of the item holder such that the item holder may not slide out of the item receiving recess without the use of the tool. Therefore, the gap is configured to press fit or friction-fit the item holder to secure the item holder to the display body.

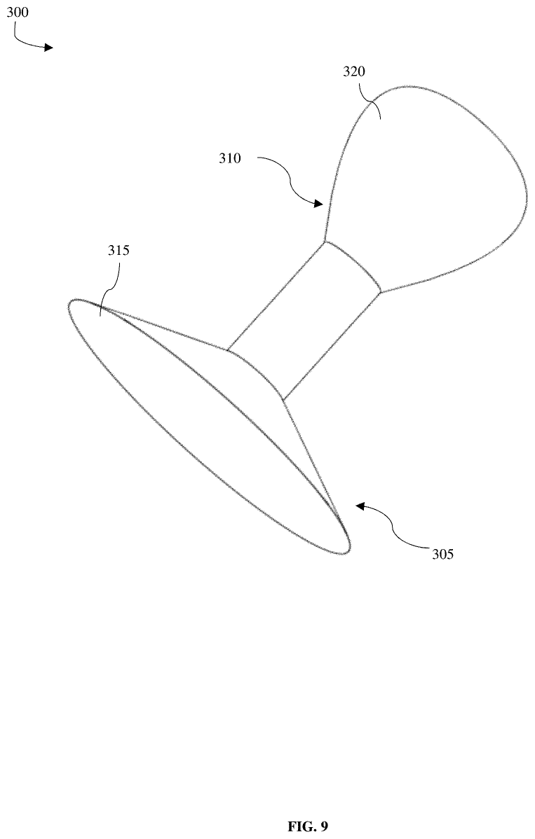

Referring now to FIG. 9, a perspective view of the tool 300 is shown, according to an example embodiment. Because of the small clearance of the gap, the gap prevents the user from using their fingers to remove the item holders from the item receiving recesses. Therefore, the tool is required to remove each item holder from its respective item receiving recesses. In the example embodiment, the user applies the suction cup end of the tool to the front facing surface of the item holder and then pulls on the item holder to remove it from it from the item receiving recess. The tool comprises a tool first end portion 305 and a tool second end portion 310. The tool first end portion includes a suction cup 315 and the tool second end portion includes a handle 320. The tool may be formed from a single piece or from several individual pieces joined or coupled together. The components of the tool may be manufactured from a variety of different processes including an extrusion process, a mold, welding, shearing, punching welding, folding etc. However, other types of processes may also be used and are within the spirit and scope of the present invention. The suction cup is configured to removably adhere to the item holder front facing side such that the user may pull on the handle to remove the item holder from the item receiving recess. The suction cup may be comprised of highly flexible synthetic material such as PVC plastic or neoprene. Other materials may be used and are withing the spirit and scope of the present invention. The handle may be merged with the suction cup during the process of creating the suction cup or in attachment with the suction cup as a separate entity. The handle may be comprised of material such as carbon steel, stainless steel, aluminum, Titanium, other metals or alloys, composites, ceramics, polymeric materials such as polycarbonates, such as Acrylonitrile butadiene styrene (ABS plastic), Lexan™, and Makrolon™. The handle may be made of other materials and is within the spirit and scope of the present invention.

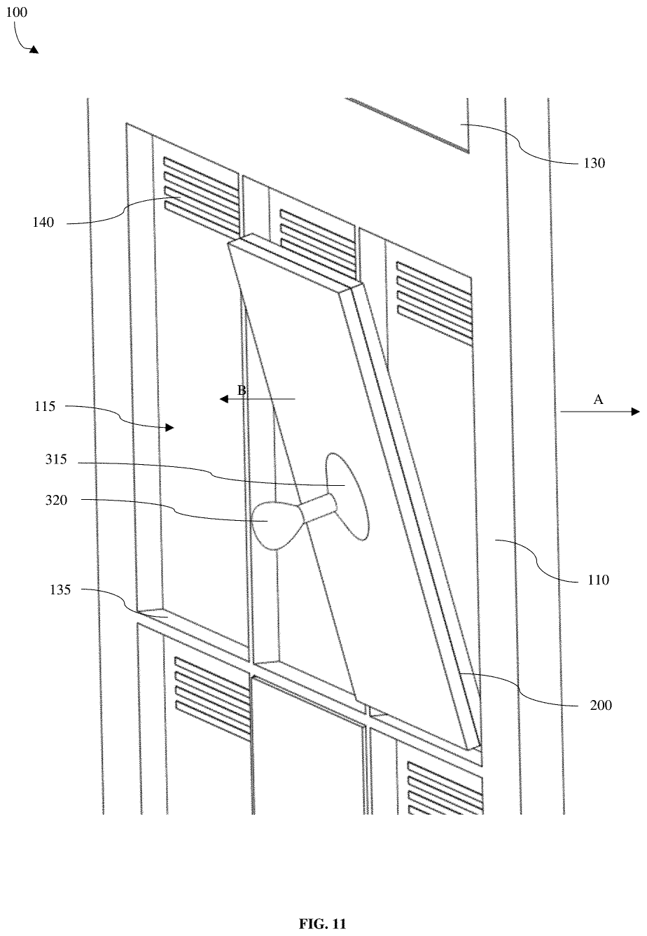

Referring now to FIGS. 10 and 11, perspective views of the display system 100 including item holders 200 and the tool 300 are shown, according to an example embodiment. FIG. 10 is a side perspective view of the display system including item holders and the tool, according to an example embodiment. FIG. 11 is a side perspective view of the display system including item holders and the tool, according to an example embodiment. In the present embodiment, the display body may have a bleed hole 162 that extends from the backwall 142 of the item receiving recess 115 to the back side 164 of the display body. The bleed hole is configured for smooth insertion of the item holder into the item receiving recess by allowing air to be released. The gap 185 may be small enough such that the air may not escape from the item receiving recess towards the display body front facing side 110, which may cause the item holder to not be fully inserted such that it is not flush with the top surface of the display body front facing side and the adjacent item holder. Therefore, the bleed hole allows air to escape through the back wall of the item receiving recess to the back side of the display body. When the item holder is covering the opening of the bleed hole that is on the back wall 142 of the item receiving recess, the air pressure within the bleed hole may create a suction force on the item holder. The suction force helps the item holder stay within the item receiving recess. However, the tool may be used to remove the item holder from the suction force. When the tool is used to insert or remove an item holder from the item receiving recess, the user avoids any direct contact to an item inside the item holder, which then avoids any damage or harm to the item. The items may be valuable or collectable graded cards that the user may want to preserve and display. The user may want to display such items because the items such as trading cards are graded by third-party services that give a score to a card to represent its value that may depend on the card's scarcity, edition, and condition. The items may also be other collectibles such as coins, stamps, trading cards, autographs, images, item patches, etc. However, other items and collectibles may be used and is within the spirit and scope of the present invention.

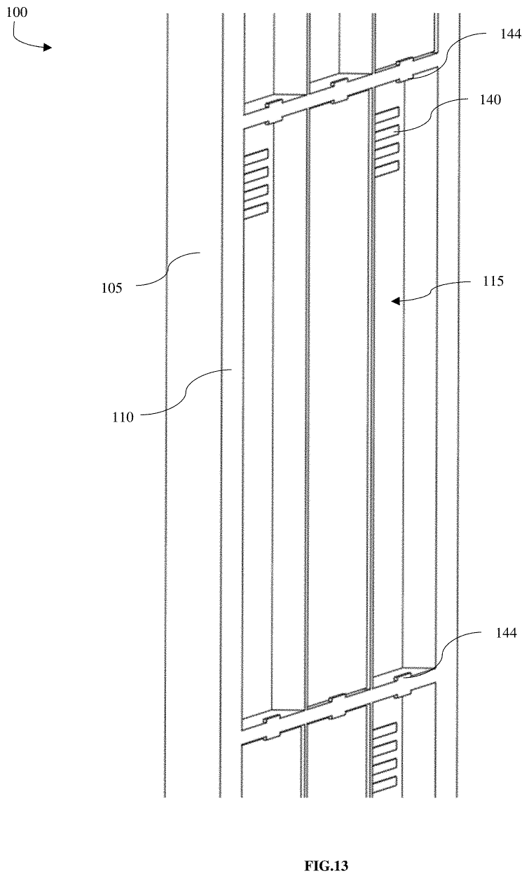

Referring now to FIGS. 13 and 14, side views of the display system 100 including item holders 200 and the tool 300 are shown, according to an example embodiment. FIG. 13 is a right side perspective view of the display system including item holders, according to an example embodiment. FIG. 14 is a left side perspective view of the display system including item holders and the tool, according to an example embodiment. In the current embodiment, the fasteners include a lip 144 on each item receiving recess 115 to hold the item holder within the item receiving recess. The lip may slightly encase at least one of the top, side, and bottom edges of the item holder front facing when the item holder is inserted into the item receiving recess. In some embodiments, the item receiving recess may have more than one lip 144 to secure the item holder within the item receiving recess, as such, the lip may be disposed in attachment with the item receiving recess on at least two of the top edge, bottom edge, left side edge, and right-side edge of the item receiving recess proximate to the front facing surface. In other embodiments, other amounts of lips or fasteners may be used to slightly protrude from the edges of the item holder front facing side such that the item holder is still removable from the item receiving recess when pulled by the tool.

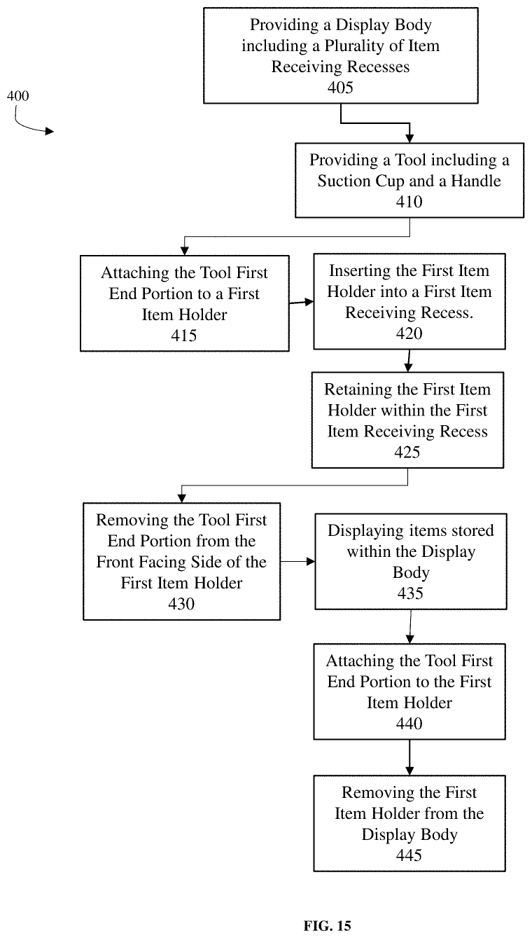

Referring now to FIG. 15, a block diagram illustrating a method 400 for retaining and displaying items is shown, according to an example embodiment. The method starts with providing a display body having a display body front facing side at step 405. The display body includes a plurality of item receiving recesses on the display body front facing side. Each of the plurality of item receiving recesses comprises a ledge 135. Next, in step 410, the method includes providing a tool configured for inserting and removing each of a plurality of item holders into and from each of the plurality of item receiving recesses. The tool includes a tool first end portion that includes a suction cup and a tool second end portion that includes a handle. The user may hold the tool by the handle to attach the suction cup to any of the plurality of item holders. Next, in step 415, the method includes attaching the tool first end portion to a front facing side of a first item holder. The user attaches the suction cup of the tool onto the front facing side of the first item holder. The suction cup adheres to the flat surface of the front facing side by using the negative fluid pressure to create a partial vacuum. Each of the plurality of item holders is configured to be removably received by at least one of the plurality of item receiving recesses. The item holders are shaped to fit flush within the item receiving recesses such that the item holders may fit into the display body like a puzzle piece. Next, in step 420, the method includes inserting the first item holder into a first item receiving recess of the plurality of item receiving recesses. In step 425, the display body retains the first item holder within the first item receiving recess using a fastener. The fastener is configured to allow the item holder to be held within the item receiving recess such that the item holders are retained in the display body while the display body is mantled or moved. However, the user may still use the tool to remove the item holder from the security of the fastener. In step 430, the user removes the tool first end portion from the front facing side of the first item holder thereby removing the suction cup from the item holder. In step 435, the method includes displaying the items stored within the display body. Next, in step 440, the user attaches the tool first end portion to the front facing side of the first item holder thereby adhering the suction cup to the item holder for removing the first item holder from the first item receiving recess. In step 445, the user removes the first item holder from the display body by forcing the item holder out of the first item receiving recess and out of the fastener. The suction cup in the tool first end portion pulls the front facing side of the first item holder away from first item receiving recess when the user pulls on the handle in the tool second end portion.

It is understood that this method is a continuous cycle and that each step of method 400 may operate concurrently with another step of method 400 to provide safe display and retention of the item holders within the display body. In other embodiments, the method may further include additional steps to promote safe retention and removal of item holders consistent with the systems disclosed herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A display system for retaining and displaying items comprising:
a. a display body having a display body front facing side;
b. a plurality of item receiving recesses on the display body front facing side, wherein each of the item receiving recesses comprises a ledge;
c. a plurality of item holders;
d. wherein each of the plurality of item holders is configured to be removably received by at least one of the plurality of item receiving recesses; and
e. wherein an item holder front facing side of a first item holder of the plurality of item holders is substantially flush with a second item holder front facing side of a second item holder of the plurality of item holders when the first item holder and the second item holder is received by two of the plurality of item receiving recesses.

2. The display system of claim 1, wherein the item holder front facing side of the first item holder of the plurality of item holders is substantially flush with a top surface of the display body front facing side when the first item holder is received by one of the plurality of item receiving recesses.

3. The display system of claim 2, wherein a gap is formed between an item holder side wall of the first item holder and an item receiving recess wall of a first item receiving recess of the plurality of item receiving recesses when the first item holder is received by the first item receiving recess, wherein the gap is at most 0.060 inches.

4. The display system of claim 3, wherein each of the item receiving recesses of the plurality of item receiving recesses has a recess depth at least as large as an item holder thickness of at least one item holder of the plurality of item holders.

5. The display system of claim 4, wherein each of the item receiving recesses of the plurality of item receiving recesses has a recess width at least as large as an item holder width of at least one item holder of the plurality of item holders.

6. The display system of claim 5, wherein each of the item receiving recesses of the plurality of item receiving recesses has a recess height at least as large as an item holder height of at least one item holder of the plurality of item holders.

7. The display system of claim 6, wherein the display system comprises a plurality of fasteners, wherein each fastener of the plurality of fasteners removably secures one of the plurality of item holders within one of the plurality of item receiving recesses.

8. The display system of claim 7, wherein the display system comprises a tool comprising a tool first end portion and a tool second end portion, wherein the tool first end portion comprises a suction cup and the tool second end portion comprises a handle.

9. The display system of claim 8, wherein the display body further comprises an upper display body section and a lower display body section, wherein the upper display body section comprises an ornamental grading plate; and wherein the lower display body section comprises the plurality of item receiving recesses.

10. A display system for retaining and displaying items comprising:
a. a display body having a display body front facing side;
b. a plurality of item receiving recesses on the display body front facing side, wherein each of the item receiving recesses comprises a ledge;
c. a plurality of item holders;
d. a tool comprising a tool first end portion and a tool second end portion, wherein the tool first end portion comprises a suction cup and the tool second end portion comprises a handle;
e. wherein each of the plurality of item holders is configured to be removably received by at least one of the plurality of item receiving recesses;
e. wherein an item holder front facing side of a first item holder of the plurality of item holders is substantially flush with a second item holder front facing side of a second item holder of the plurality of item holders when the first item holder and the second item holder is received by two of the plurality of item receiving recesses; and
g. wherein the tool is configured for inserting and removing each of the plurality of item holders into and from each of the plurality of item receiving recesses.

11. The display system of claim 10, wherein the item holder front facing side of the first item holder of the plurality of item holders is substantially flush with a top surface of the display body front facing side when the first item holder is received by one of the plurality of item receiving recesses.

12. The display system of claim 11, wherein each of the item receiving recesses of the plurality of item receiving recesses has a recess depth at least as large as an item holder thickness of at least one item holder of the plurality of item holders.

13. The display system of claim 10, wherein a gap is formed between an item holder side wall of the first item holder and an item receiving recess wall of a first item receiving recess of the plurality of item receiving recesses when the first item holder is received by the first item receiving recess, wherein the gap is at most 0.060 inches.

14. The display system of claim 10, wherein the display system comprises a plurality of fasteners, wherein each fastener is configured to removably secure one of the plurality of item holders within one of the plurality of item receiving recesses.

15. The display system of claim 10, wherein each of the item receiving recesses of the plurality of item receiving recesses has a recess width at least as large as an item holder width of at least one item holder of the plurality of item holders.

16. The display system of claim 10, wherein each of the item receiving recesses of the plurality of item receiving recesses has a recess height at least as large as an item holder height of at least one item holder of the plurality of item holders.

17. The display system of claim 10, wherein the display body further comprises an upper display body section and a lower display body section, wherein the upper display body section comprises an ornamental grading plate; and wherein the lower display body section comprises the plurality of item receiving recesses.

18. A method for retaining and displaying items comprising:
a. providing a display body having a display body front facing side, wherein the display body comprises, a plurality of item receiving recesses on the display body front facing side, and wherein each of the plurality of item receiving recesses comprises a ledge;
b. providing a tool configured for inserting and removing each of a plurality of item holders into and from each of the plurality of item receiving recesses, wherein the tool comprises a tool first end portion and a tool second end portion, and wherein the tool first end portion comprises a suction cup and the tool second end portion comprises a handle;
c. attaching the tool first end portion to a front facing side of a first item holder of the plurality of item holders, wherein each of the plurality of item holders is configured to be removably received by at least one of the plurality of item receiving recesses;
d. inserting the first item holder into a first item receiving recess of the plurality of item receiving recesses;
e. retaining the first item holder within the first item receiving recess;
f. removing the tool first end portion from the front facing side of the first item holder; and
g. displaying items stored within the display body.

19. The method of claim 18 further comprising attaching the tool second end portion to the first item holder for removing the first item holder from the first item receiving recess.

20. The method of claim 19 further comprising removing the first item holder from the display body.
